(19) United States
(12) Patent Application Publication
(10) Pub. No.: US 2008/0106896 A1
(43) Pub. Date: May 8, 2008

(54) Illumination device for coupling with cup structure

(75) Inventors: Shih-Ta Liu, Lu Jhu (TW); Po-Chang Liu, Lu-Jhu (TW); Yu-Jen Liu, Lu Jhu (TW); Shua-Lien Li, Lu Jhu (TW)

Correspondence Address: TROXELL LAW OFFICE PLLC, Suite 1404, 5205 Leesburg Pike, Falls Church, VA, 22041, US

(73) Assignee: Biboting International Co., Ltd.

(21) Appl. No.: 11/592,234

(22) Filed: Nov. 3, 2006

(51) Int. Cl. F21V 33/00

(52) U.S. Cl. 362/234

(57) ABSTRACT

An illumination device for coupling with a cup structure is disclosed. The illumination device comprises a plurality of light sources disposed therein so as to provide the cup structure with illumination effect. The light sources are such as LED lamps for generating light beams of proper wavelengths so as to produce different medical purposes including eliminating wrinkles, enhancing elasticity, sterilization, relieving itching, and reducing inflammation. The illumination device can be attached to or detached from the connection part of the cup structure or the outer lateral of the cup structure easily. The cup structure is a breast-enhancing cup or a cupping cup. In addition, the heaters, the far infrared emitters, or the magnets are mounted on the inside of the illumination device so as to provide with more effects.

### FIELD OF THE INVENTION

The present invention relates to an illumination device for coupling with a cup structure such as a breast-enhancing cup or a cupping cup.

### BACKGROUND OF THE INVENTION

The general cup structure such as a breast-enhancing cup, a cupping cup, or a cup for other purposes is widely, publicly utilized. At first the breast-enhancing cup is applied for enlarging the breast. After many years of verification, the cup structure that enhances the blast also provides the function of exercising the blast for promoting blood and lymph circulation and eliminating the poison from the blast. As a result, the cup structure can exercise the blast to reduce the blast disease. It proves that the exercise can help prevent disease.

The cupping therapy is a traditional Chinese medical skill that promotes the lymphatic drainage of the body so as to provide the healthy body. In addition, the traditional medical therapy also utilizes the cupping cup to perform the skidding treatment for promoting the lymphatic drainage.

The traditional medical therapy has been disclosed for many years, but no new apparatus was provided. As a result, there is provided with a general cup structure on which a heater and a vibrator are attached thereon so as to transform the traditional simple medical therapy into a multi-functional breast-enhancing or other-purpose cup.

As shown in FIG. 1, a general cup structure 10 such as a breast-enhancing cup, a cupping cup, or a cup for other purposes has an opening on end for contact with skin and a connection part 101 on the other end for connection with a gas suction pump. For the purpose of providing special functions or effects, a mechanism case 20 is attached to the cup structure 10. In addition, a heater may be mounted on the inside of the machine case 20 so as to provide the cup structure with the heating function. Besides, a magnet, a far infrared ceramic, and a vibrator may be also mounted on the inside of the machine case 20 so as to provide the functions of magnetic wave, far infrared wave and vibration.

### SUMMARY OF THE INVENTION

A main object of the present invention is to provide an illumination device for coupling with a cup structure, wherein the illumination device has light sources disposed therein so as to provide the cup structure with special illumination effects.

The illumination device has the light sources such as LED lamps for generating light beams of proper wavelengths so as to produce different medical purposes including eliminating wrinkles, enhancing elasticity, sterilization, relieving itching, and reducing inflammation.

The illumination device is easily attachable to the cup structure. In addition, the light sources, the heaters, the far infrared ceramics, or the magnets can be disposed on the inside of the illumination device so as to provide the cup structure with more special effects. The illumination device, which is easily detachable, can be fixed on the cup structure 1 by screws, tongue-and-groove joints, or adhesives.

### BRIEF DESCRIPTION OF THE DRAWINGS

FIG. 1 is an elevational view showing a conventional cup structure and an attached conventional means.

FIG. 2 is an elevational view showing a cup structure and an attached illumination device in accordance with a first preferred embodiment of the present invention.

FIG. 3 is an elevational view showing the illumination device of the present invention.

FIG. 4 is a cross-sectional view showing the illumination device of the present invention.

FIG. 5 is an elevational view showing a cup structure and an attached illumination device in accordance with a second preferred embodiment of the present invention.

FIG. 6 is an elevational view showing the internal structure of the illumination device in accordance with the second preferred embodiment of the present invention.

FIG. 7 is a cross-sectional view showing the illumination device and the cup structure in accordance with the second preferred embodiment of the present invention.

FIG. 8 is a cross-sectional view showing the application example of the illumination device that attaches to the cup structure of the present invention.

FIG. 9 is a cross-sectional view showing the application example of the illumination device in accordance with the second preferred embodiment of the present invention.

FIG. 10 is a cross-sectional view showing the application example of the illumination device in accordance with the second preferred embodiment of the present invention.

FIG. 11 is a cross-sectional view showing the application example of the illumination device that attaches to the cup structure in accordance with the second preferred embodiment of the present invention.

FIG. 12 is a planar view showing the application example of the illumination device in accordance with the second preferred embodiment of the present invention.

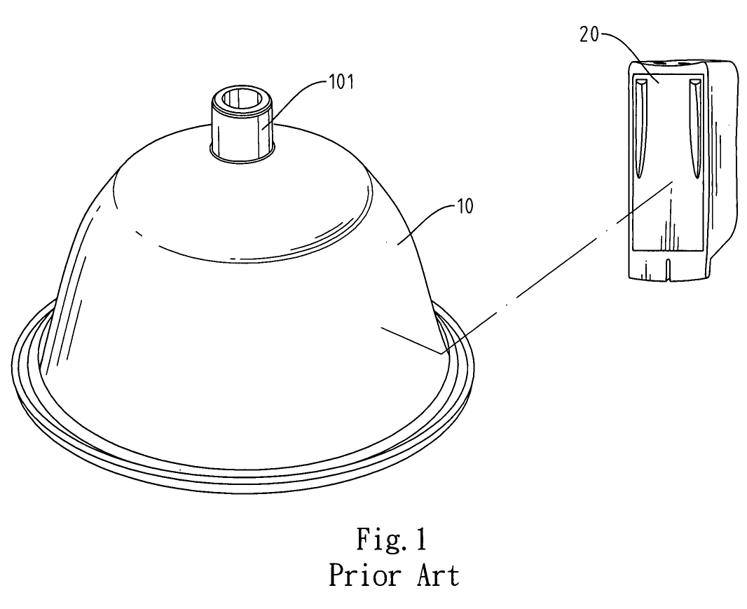

### DETAILED DESCRIPTION OF THE PREFERRED EMBODIMENT

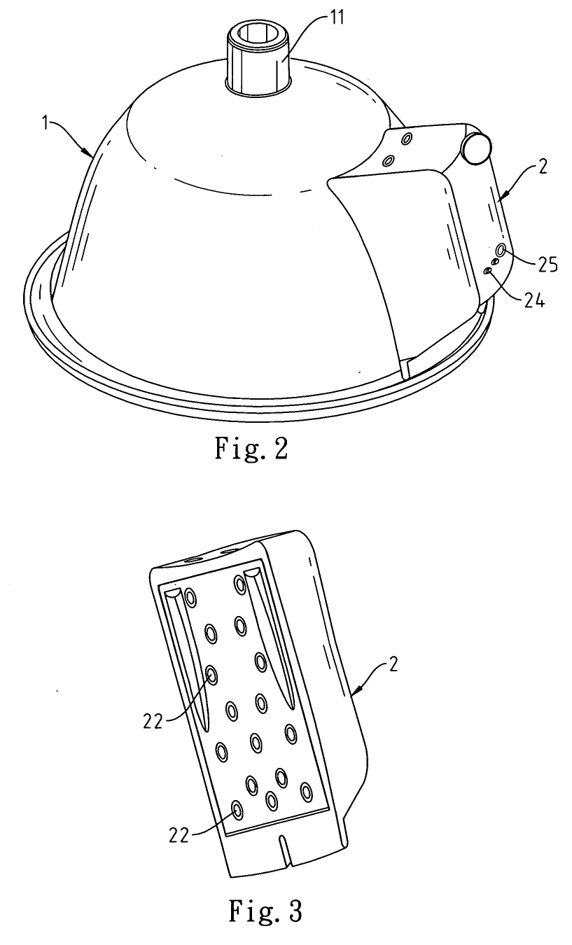

Referring to FIG. 2 through FIG. 4, an illumination device for coupling with a cup structure in accordance with a first preferred embodiment of the present invention is shown. A cup structure 1 on which an illumination device 2 is attached is provided. This cup structure 1 is a breast-enhancing cup or a cupping cup. This cup structure 1 has an opening on one end for contact with skin and a connection part 11 on the other end for connection with a gas suction pump. As explained below with diagrams, the illumination device 2 has several light sources 22 mounted therein so as to provide the cup structure 1 with special illumination effects.

The illumination device 2 has several light sources 22 mounted therein. The illumination device 2 has a bottom surface 21 that contacts with the cup structure 1 and faces the skin, wherein the light sources 22 such as any colored LED lamps or heat-generating bulbs are disposed on the bottom surface 21. The illumination device 2 has at least one control switch 24 mounted thereon for controlling the light sources 22, respectively. The illumination device 2 has a power socket 25 disposed thereon, wherein this power socket 25 is optionally replaced by a battery. The illumination device 2 can be fixed on the cup structure 1 by screws, nuts, tongue-and-groove joints, rubbers, or adhesives. Besides, the control switch 24 may be button-free so that the light sources 22 are lighted up when the power socket 25 is electrified.

The light sources 22 of the illumination device 2 can produce different purposes and effects. For example, the light sources 22 such as LED lamps that generate light beams of proper wavelengths can produce different medical purposes including eliminating wrinkles, enhancing elasticity, sterilization, relieving itching, and reducing inflammation.

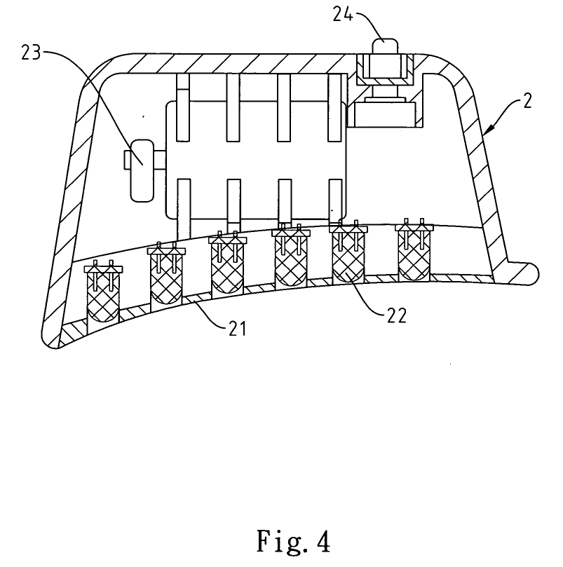

In addition, as shown in FIG. 4, the illumination device 2 has a vibration motor 23 mounted thereon to provide vibration massage.

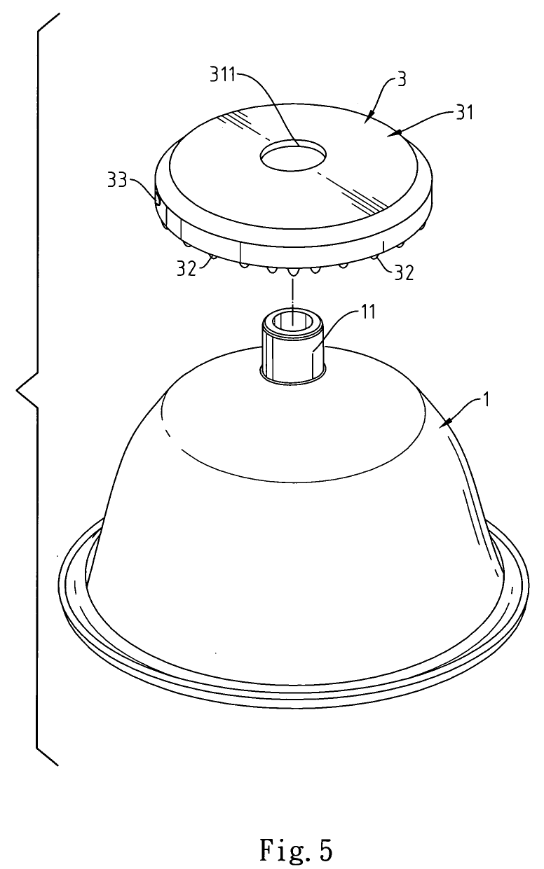

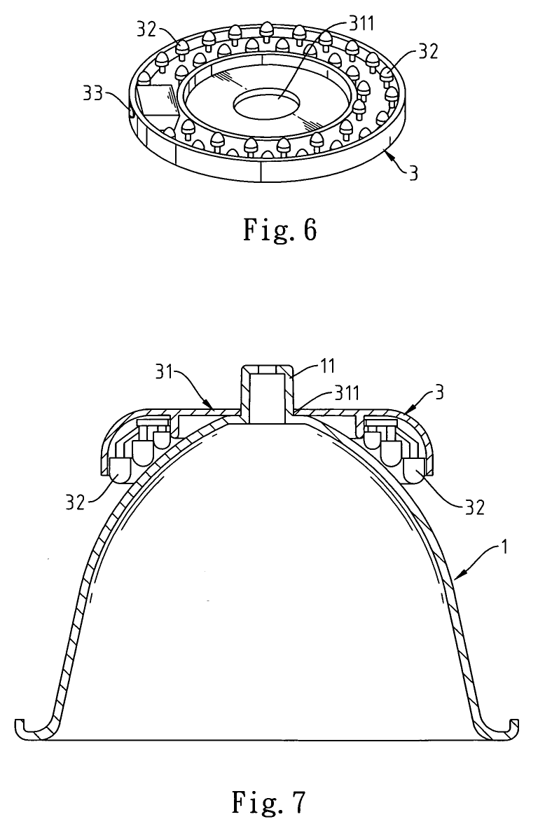

Referring to FIGS. 5 through 12, a second preferred embodiment of the present invention is shown. The cup structure 1 has an opening on one end for contact with skin and a connection part 11 on the other end for connection with a gas suction pump. The cup structure 1 may have different sizes. Moreover, one or two connection parts 11, which are identical in size, may be mounted in the cup structure 1.

In this preferred embodiment, the connection part 11 of the cup structure 1 can be sleeved into an illumination device 3. This illumination device 3 is a circular cover 31 having a central hole 311 on the center for coupling with the connection part 11 of the cup structure 1. Several light sources 32 such as LED lamps are mounted circularly on the inside of the circular cover 31. The light sources 32 are designed to generate many-colored light beams. In addition, the light sources 32 are optionally twinkling lights. The illumination device 3 has a power socket 33 disposed on one side. In addition, the illumination device 3 also has a battery disposed thereon for providing easiness of use. When the illumination device 3 couples with the cup structure 1, the connection part 11 of the cup structure 1 can be inserted into the central hole 311 of the circular cover 31 so as to attach the circular cover 31 to the cup structure 1. Moreover, the light beams emitted from the light sources 32 such as LED lamps can penetrate the cup structure 1 so as to achieve the purpose of illuminating the skin.

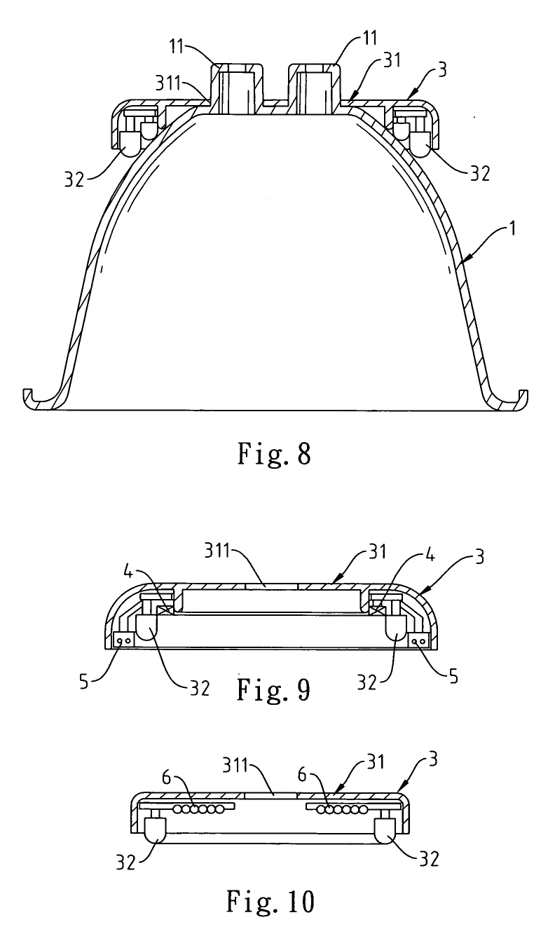

The circular cover 31 of the illumination device 3 can be coupled with different cup structure 1, which is such as thin-sized, medium-sized, or flat. As shown in FIG. 8, the cup structure 1 has two connection parts 11. Accordingly, the circular cover 31 also has two central holes 311 so as to allow these two connection parts 11 of the cup structure 1 to insert thereinto.

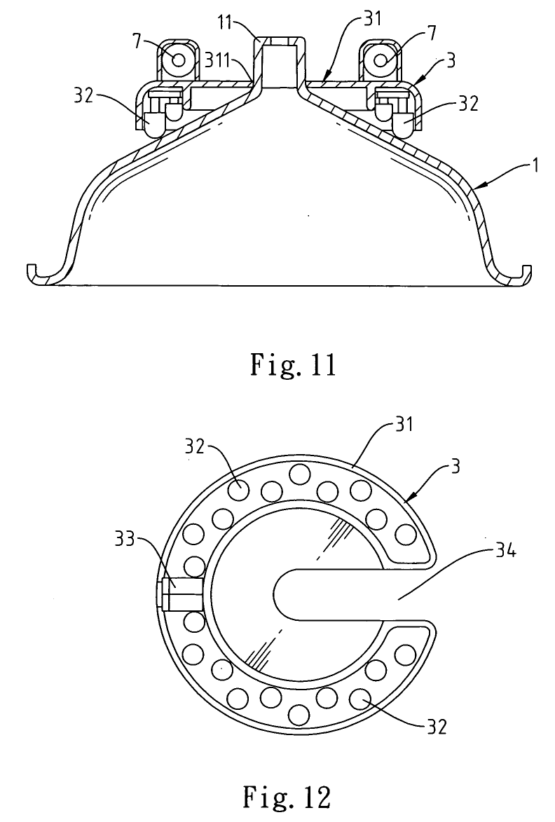

As shown in FIG. 9, the circular cover 31 has several magnets 4 and heaters 5 disposed thereon. As shown in FIG. 10, the circular cover 31 has several far infrared emitters 6 disposed thereon. Alternatively, as shown in FIG. 11, a battery case 7 is attached to the top of the circular cover 31 for providing easiness of use.

Moreover, as shown in FIG. 12, the circular cover 31 has a notch 34 on the lateral so as to facilitate the insertion of the connection part 11 of the cup structure 1 into the circular cover 31. In other words, the circular cover 31 is easily detachable by using the notch 34. Furthermore, for the purpose of fixing it, a protrudent ear can be disposed on the inside of the notch 34.

The cup structure 1 on which the circular cover 31 of the illumination device 3 is attached is a breast-enhancing cup or a cupping cup. The circular cover 31 is easily detachable from the connection part 11 of the cup structure 1. Optionally, the notch 34 is formed on the lateral of the circular cover 31 so as to facilitate the insertion of the connection part 11 of the cup structure 1 into the circular cover 31. Accordingly, the circular cover 31 can be attached to or detached from the connection part 11 easily. In addition, the light sources 32, the heaters 5, the far infrared emitters 6, or the magnets can be disposed on the inside of the circular cover 31 so as to provide the cup structure 1 that has the circular cover 31 attached thereon with more effects.

What the invention claimed is:

1. An illumination device for coupling with a cup structure comprising:
a plurality of light sources disposed on the inside of said illumination device for providing said cup structure with illumination effect, said light sources comprising LED lamps or heat-generating bulbs.

2. An illumination device for coupling with a cup structure of claim 1, wherein said illumination device is attached to one side of said cup structure.

3. An illumination device for coupling with a cup structure of claim 1, wherein said illumination device is attached to a connection part, which is formed on the top of said cup structure.

4. An illumination device for coupling with a cup structure of claim 1, wherein said illumination device is a circular cover having a central hole on the center for coupling with a connection part, which is formed on the top of said cup structure.

5. An illumination device for coupling with a cup structure of claim 1, wherein said illumination device is a circular cover having a notch on the lateral so as to facilitate the insertion of a connection part, which is formed on the top of said cup structure, into said circular cover.

6. An illumination device for coupling with a cup structure of claim 1, wherein said illumination device has one or more switches for controlling said light sources simultaneously or respectively.

7. An illumination device for coupling with a cup structure of claim 1, wherein said illumination device has a vibration motor, a vacuum pump, a gas exhaustion valve, a heater, a magnet, or a far infrared emitter attached thereon.
